(19) United States
(12) Patent Application Publication
(10) Pub. No.: US 2022/0321434 A1
(43) Pub. Date: Oct. 6, 2022

(54) METHOD AND APPARATUS TO STORE AND PROCESS TELEMETRY DATA IN A NETWORK DEVICE IN A DATA CENTER

(71) Applicant: Intel Corporation, Santa Clara, CA (US)

(72) Inventors: Andrzej KURIATA, Gdansk (PL); Francesc GUIM BERNAT, Barcelona (ES); Karthik KUMAR, Chandler, AZ (US); Susanne M. BALLE, Hudson, NH (US); Alexander BACHMUTSKY, Sunnyvale, CA (US); Duane E. GALBI, Wayland, MA (US); Nagabhushan CHITLUR, Portland, OR (US); Sundar NADATHUR, Cupertino, CA (US)

(21) Appl. No.: 17/848,898

(22) Filed: Jun. 24, 2022

(51) Int. Cl. H04L 43/04; G06F 9/54; H04L 67/133; H04L 43/0852; H04L 67/51

(52) U.S. Cl. CPC H04L 43/04; G06F 9/547; H04L 67/133; H04L 43/0858; H04L 67/51

(57) ABSTRACT

Reliability and performance of a data center is increased by processing telemetry data in a network device in the data center. A Telemetry Correlation Engine (TCE) in the network device correlates host level telemetry received from a compute node with low-level network device telemetry collected in the network device to identify performance bottlenecks for microservices based applications. The Telemetry Correlation Engine processes and analyzes the telemetry data from the compute node and network statistics available in the network device.

### BACKGROUND

Cloud computing provides access to servers, storage, databases, and a broad set of application services over the Internet. A cloud service provider offers cloud services such as network services and business applications that are hosted in servers in one or more data centers that can be accessed by companies or individuals over the Internet. Hyperscale cloud-service providers typically have hundreds of thousands of servers. Each server in a hyperscale cloud includes storage devices to store user data, for example, user data for business intelligence, data mining, analytics, social media and microservices. The cloud service provider generates revenue from companies and individuals (also referred to as tenants) that use the cloud services.

Disaggregated computing or Composable Disaggregated Infrastructure (CDI) is an emerging technology that makes use of high bandwidth, low-latency interconnects to aggregate compute, storage, memory, and networking fabric resources into shared resource pools that can be provisioned on demand.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a simplified diagram of at least one embodiment of a data center for executing workloads with disaggregated resources;

FIG. 2 is a simplified diagram of at least one embodiment of a pod that may be included in a data center;

FIG. 3 is a simplified block diagram of at least one embodiment of a top side of a node;

FIG. 4 is a simplified block diagram of at least one embodiment of a bottom side of a node;

FIG. 5 is a simplified block diagram of at least one embodiment of a compute node;

FIG. 6 is a simplified block diagram of at least one embodiment of an accelerator node usable in a data center;

FIG. 7 is a simplified block diagram of at least one embodiment of a storage node usable in a data center;

FIG. 8 is a simplified block diagram of at least one embodiment of a memory node usable in a data center;

FIG. 9 depicts a system for executing one or more workloads;

FIG. 10 illustrates a compute node that includes an Infrastructure Processing Unit (IPU);

FIG. 11 is a block diagram including logic/circuitry in the IPU to store and process telemetry data;

FIG. 12 is a block diagram of a system that includes an IPU to store and process host telemetry data and network telemetry data;

FIG. 13 is a flowgraph illustrating a method performed in the IPU shown in FIG. 12 to improve performance of microservices;

FIG. 14 is a flowgraph illustrating a method for configuring the IPU to store and process telemetry data;

FIG. 15 is a flowgraph illustrating a method for performing data collection in the system shown in FIG. 12;

FIG. 16 is a flowgraph illustrating a method for processing the telemetry data and the network telemetry/statistics; and

FIG. 17 is a flowgraph illustrating a method for exposing the data processed by the TCE agent in the IPU.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DESCRIPTION OF EMBODIMENTS

High speed networks are essential for supporting business, providing communication, and delivering entertainment. To increase network speed, Cloud service providers (CSPs) are evolving their hardware platforms by offering central processing units (CPUs), general purpose graphics processing units (GPGPUs), custom XPUs, and pooled storage and memory (for example, DDR, persistent memory, 3D XPoint, Optane, or memory devices that use chalcogenide glass). CSPs are vertically integrating these with custom orchestration control planes to expose these as services to users.

Growth in cloud native, scale out in applications, emergence of Compute Express Link (CXL) based protocols to stitch together systems and resources across multiple platforms, and increased and enhanced usages and capabilities offered by XPUs (for example, GPUs and Infrastructure Processing Units (IPUs)) have led a shift from core and CPU focused computing, to computing that spans multiple platforms and even multiple datacenters.

While this massive expansion in “compute” real estate offers a huge potential for applications in terms of usages and performance; there comes with it the challenges of debug and analyses at scale. Debugging applications at a single node level involves and necessitates performance counters in hardware to be analyzed on the fly. Currently low-level telemetry (including network data) is retrieved on the host and processed there. External systems are used to retrieve in-band data from hosts and out-of-band data from hardware. The retrieved telemetry data are stored and processed on an external system/server.

Retrieving, processing and storing low-level telemetry on the host is expensive, especially in terms of resources that could be otherwise used for customer workloads. Retrieving the in-band telemetry from the hosts and the out-of-band telemetry from the hardware to correlate on an external system is complicated, increases the data path causing more latency and potential reliability/stability risks.

Cloud Service Providers (CSPs) can remove slow features from the CPU and put them in an Infrastructure Processing Unit (IPU). An Infrastructure Processing Unit (IPU) is a programmable network device that intelligently manages system-level resources by securely accelerating networking and storage infrastructure functions in a disaggregated computing system data center. Systems can be composed differently based at least on how functions are mapped and offloaded.

Kubernetes is an open-source container orchestration system for automating software deployment, scaling, and management. A kubernetes pod is a group of one or more containers, with shared storage and network resources. Telemetry data can be collected for each container. The telemetry data for the container can be used to determine the resources (for example, CPU resources and memory resources) that are being used by the container. An application can include a collection of containers (also referred to as microservices).

Currently the IPU exposes thousands of metrics that are difficult to comprehend on a host level and need to be correlated with other metrics like CPU and memory utilization to discover correlations between applications performance and resources utilization, including performance bottlenecks identification. Proliferation of microservices based architectures (and increasing popularity of service mesh solutions) increase the importance of per-workload (container/pod) networking statistics to understand individual microservice and application based on microservices performance.

Reliability and performance can be increased by storing and processing telemetry data on the IPU. A Telemetry Correlation Engine (TCE) in the IPU correlates host level telemetry with low-level IPU telemetry to identify performance bottlenecks for microservices based applications. Examples of host level telemetry include per container telemetry and Kubernetes pod telemetry. Examples of low-level IPU telemetry include network telemetry, for example, In-band Network Telemetry (INT), and Platform Management Monitoring (PMT).

In-band Network Telemetry (INT) allows the collection and reporting of network state, by the data plane, without requiring intervention or work by the control plane in collecting and delivering the state from the data plane. Packets may contain header fields that are interpreted as telemetry instructions by network devices. The telemetry instructions indicate the state to be collected by the network devices. INT traffic sources (applications, end-host networking stacks, hypervisors, NICs, send-side ToRs, etc.) can embed the instructions either in normal data packets, cloned copies of the data packets or in special probe packets or the instructions may be programmed in the network data plane to match on particular network flows and to execute the instructions on the matched flows.

The Telemetry Correlation Engine processes and analyzes host level telemetry data from the host and network statistics available directly on the IPU and provides the processed data to a Cloud Service Operator. The Cloud Service Operator can be Kubernetes and the workload that is analyzed is the Kubernetes pod. Metrics are correlated for the Kubernetes pod. For example, the Telemetry Correlation Engine can perform time-based correlation, correlation of application level metrics (for example, the number of database queries) to network metrics (for example, utilized bandwidth). The number of database queries is reduced if the network bandwidth is saturated.

Processed data can be exposed on several interfaces. There is no need to run telemetry data storage and processing on the host, thus more resources (for example, CPU cores) can be devoted to user workload processing.

The IPU is aware of the topological characteristics of the application and which local resources (both platform resources and CXL attached resources) and remote resources (for example, CXL over fabric and remote storage) and the performance requirements (either Service Level Agreement (SLA) or Service Level Objective (SLO)) associated with the services.

The IPU can track the application Key Performance Indicator (KPI) of the different services running on the system and establish Service Level Agreement violations and correlate them with the different topological building blocks that are part of the service or application. Using this end-to-end telemetry and using techniques such as Top-down Microarchitecture Analysis Method (TMAM), the IPU can determine the problems and can call back to the orchestration and the management layer for remediation.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

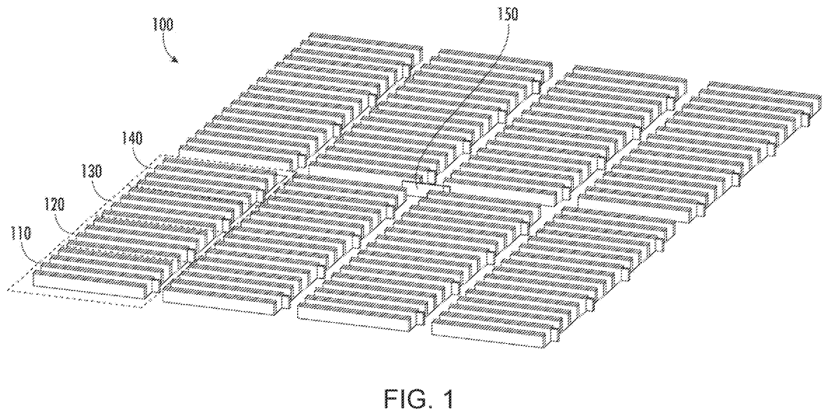

FIG. 1 depicts a data center 100 in which resources cooperatively execute one or more workloads (for example, applications on behalf of users (customers)) that includes multiple pods 110, 120, 130, 140, a pod being or including one or more rows of racks. Of course, although data center 100 is shown with multiple pods, in some embodiments, the data center 100 may be embodied as a single pod. As described in more detail herein, each rack houses multiple nodes, some of which may be equipped with one or more type of resources (for example, memory devices, data storage devices, accelerator devices, general purpose processors). Resources can be logically coupled to form a composed node or composite node, which can act as, for example, a server to perform a job, workload or microservices. In the illustrative embodiment, the nodes in each pod 110, 120, 130, 140 are connected to multiple pod switches (for example, switches that route data communications to and from nodes within the pod). The pod switches, in turn, connect with spine switches 150 that switch communications among pods (for example, the pods 110, 120, 130, 140) in the data center 100. In some embodiments, the nodes may be connected with a fabric using Intel® Omni-Path technology. In other embodiments, the nodes may be connected with other fabrics, such as InfiniBand or Ethernet or PCI Express or direct optical interconnect. As described in more detail herein, resources within nodes in the data center 100 may be allocated to a group (referred to herein as a “managed node”) containing resources from one or more nodes to be collectively utilized in the execution of a workload. The workload can execute as if the resources belonging to the managed node were located on the same node. The resources in a managed node may belong to nodes belonging to different racks, and even to different pods 110, 120, 130, 140. As such, some resources of a single node may be allocated to one managed node while other resources of the same node are allocated to a different managed node (for example, one processor assigned to one managed node and another processor of the same node assigned to a different managed node).

A data center comprising disaggregated resources, such as data center 100, can be used in a wide variety of contexts, such as enterprise, government, cloud service provider, and communications service provider (for example, Telcos), as well in a wide variety of sizes, from cloud service provider mega-data centers that consume over 60,000 sq. ft. to single- or multi-rack installations for use in base stations.

The disaggregation of resources to nodes comprised predominantly of a single type of resource (for example, compute nodes comprising primarily compute resources, memory nodes containing primarily memory resources), and the selective allocation and deallocation of the disaggregated resources to form a managed node assigned to execute a workload improves the operation and resource usage of the data center 100 relative to typical data centers comprised of hyperconverged servers containing compute, memory, storage and perhaps additional resources in a single chassis. For example, because nodes predominantly contain resources of a particular type, resources of a given type can be upgraded independently of other resources. Additionally, because different resource types (processors, storage, accelerators, etc.) typically have different refresh rates, greater resource utilization and reduced total cost of ownership may be achieved. For example, a data center operator can upgrade the processors throughout their facility by only swapping out the compute nodes. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

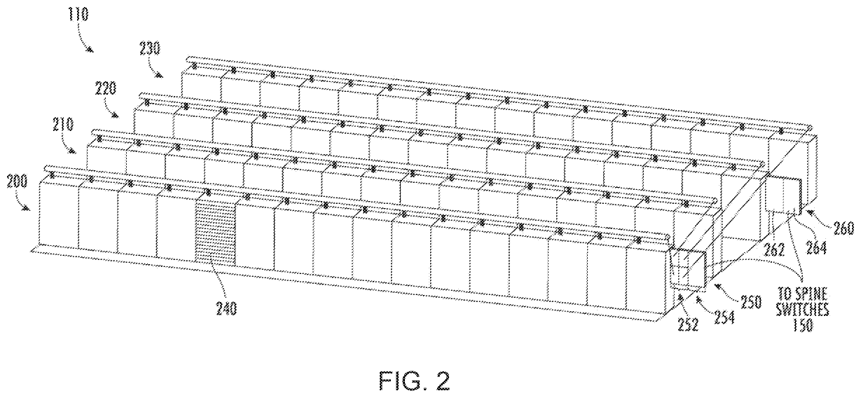

FIG. 2 depicts the pod 110 in data center 100. The pod 110 can include a set of rows 200, 210, 220, 230 of racks 240. Each rack 240 may house multiple nodes (for example, sixteen nodes) and provide power and data connections to the housed nodes, as described in more detail herein. In the illustrative embodiment, the racks in each row 200, 210, 220, 230 are connected to multiple pod switches 250, 260. The pod switch 250 includes a set of ports 252 to which the nodes of the racks of the pod 110 are connected and another set of ports 254 that connect the pod 110 to the spine switches 150 to provide connectivity to other pods in the data center 100. Similarly, the pod switch 260 includes a set of ports 262 to which the nodes of the racks of the pod 110 are connected and a set of ports 264 that connect the pod 110 to the spine switches 150. As such, the use of the pair of switches 250, 260 provides an amount of redundancy to the pod 110. For example, if either of the switches 250, 260 fails, the nodes in the pod 110 may still maintain data communication with the remainder of the data center 100 (for example, nodes of other pods) through the other switch 250, 260. Furthermore, in the illustrative embodiment, the switches 150, 250, 260 may be embodied as dual-mode optical switches, capable of routing both Ethernet protocol communications carrying Internet Protocol (IP) packets and communications according to a second, high-performance link-layer protocol (for example, PCI Express or Compute Express Link) via optical signaling media of an optical fabric.

It should be appreciated that each of the other pods 120, 130, 140 (as well as any additional pods of the data center 100) may be similarly structured as, and have components similar to, the pod 110 shown in and described in regard to FIG. 2 (for example, each pod may have rows of racks housing multiple nodes as described above). Additionally, while two pod switches 250, 260 are shown, it should be understood that in other embodiments, each pod 110, 120, 130, 140 may be connected to a different number of pod switches, providing even more failover capacity. Of course, in other embodiments, pods may be arranged differently than the rows-of-racks configuration shown in FIGS. 1-2. For example, a pod may be embodied as multiple sets of racks in which each set of racks is arranged radially, for example, the racks are equidistant from a center switch.

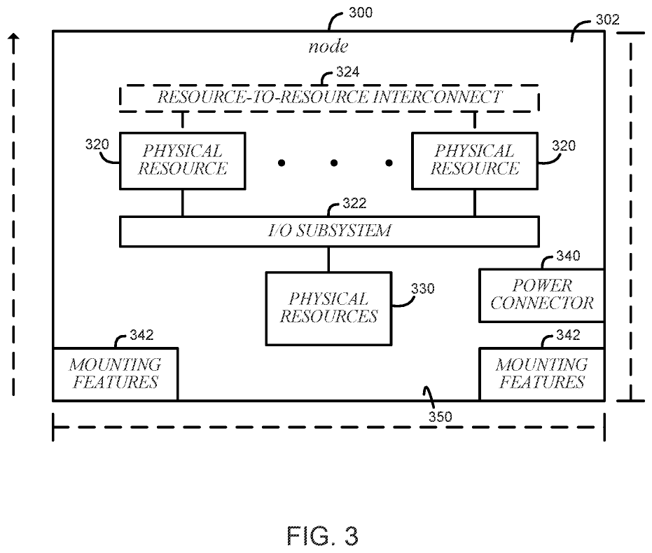

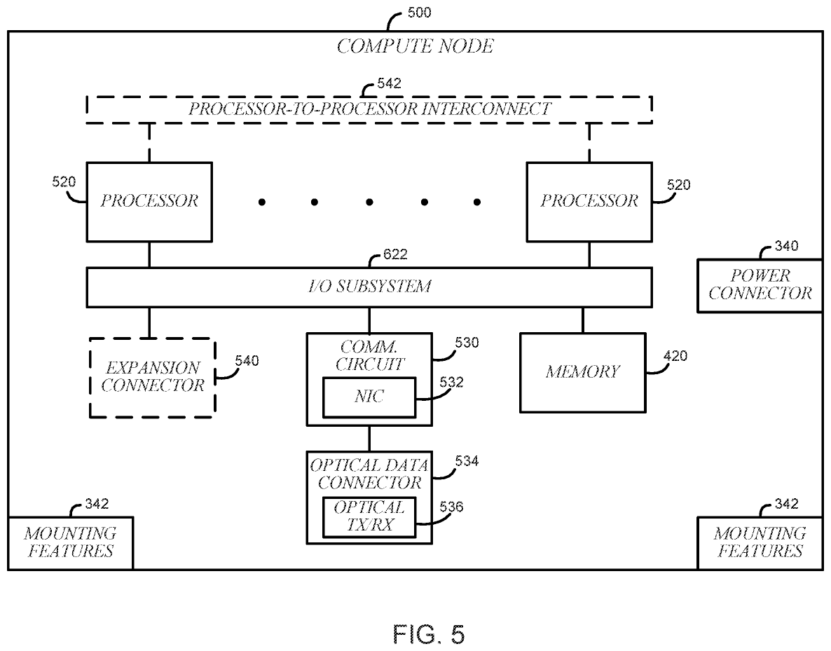

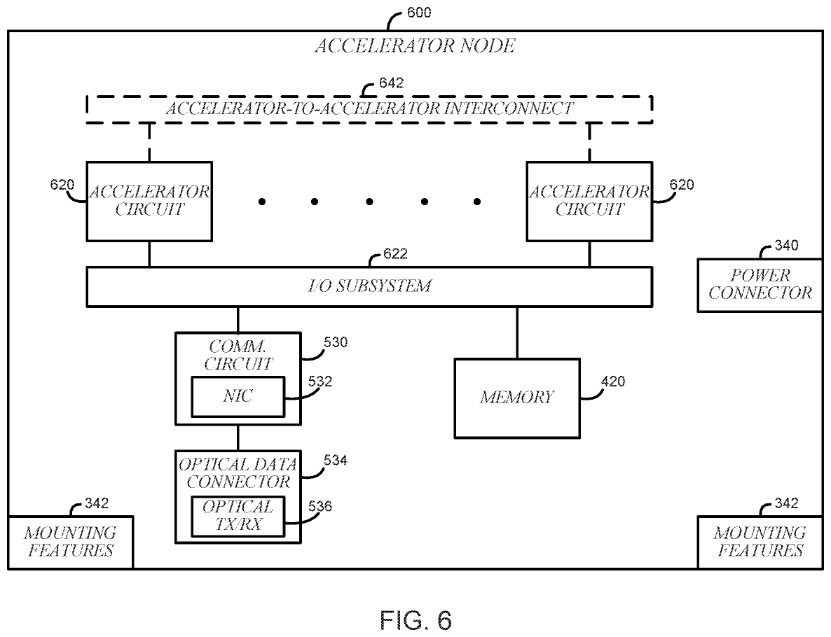

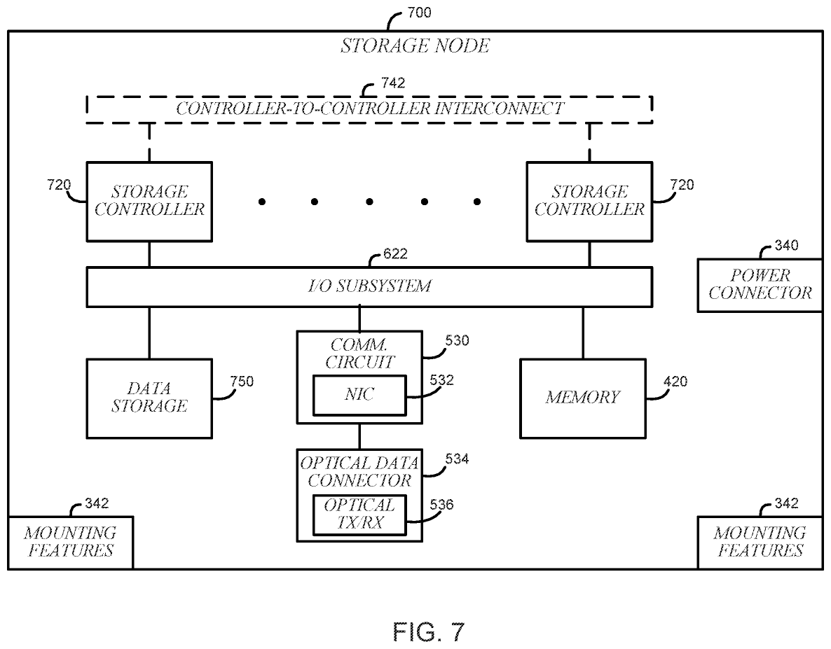

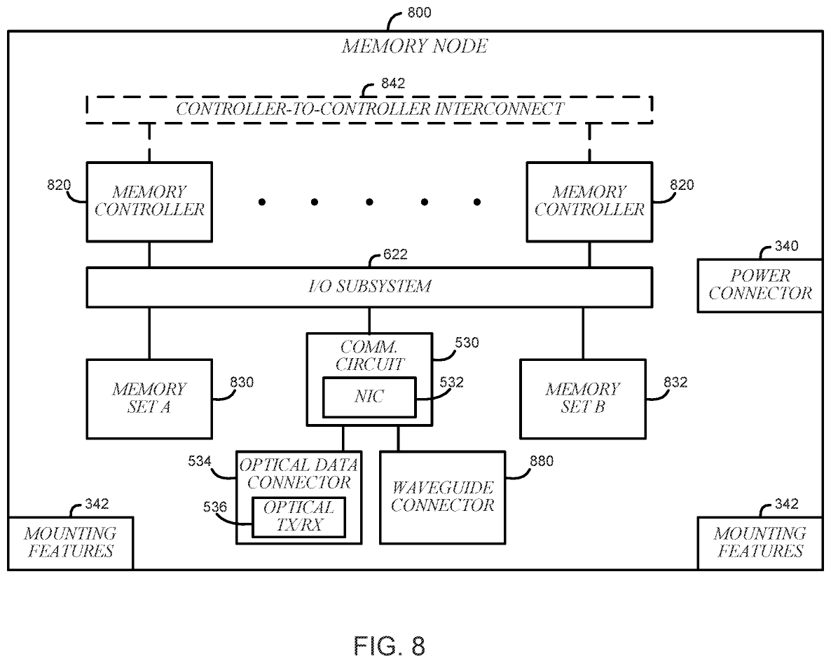

Referring now to FIG. 3, node 300, in the illustrative embodiment, is configured to be mounted in a corresponding rack 240 of the data center 100 as discussed above. In some embodiments, each node 300 may be optimized or otherwise configured for performing particular tasks, such as compute tasks, acceleration tasks, data storage tasks, etc. For example, the node 300 may be embodied as a compute node 500 as discussed below in regard to FIG. 5, an accelerator node 600 as discussed below in regard to FIG. 6, a storage node 700 as discussed below in regard to FIG. 7, or as a node optimized or otherwise configured to perform other specialized tasks, such as a memory node 800, discussed below in regard to FIG. 8. Each rack 240 may contain one or more nodes of a single or multiple node types—compute, storage, accelerator, memory, or others.

As discussed above, the illustrative node 300 includes a circuit board substrate 302, which supports various physical resources (for example, electrical components) mounted thereon.

As discussed above, the illustrative node 300 includes one or more physical resources 320 mounted to a top side 350 of the circuit board substrate 302. Although two physical resources 320 are shown in FIG. 3, it should be appreciated that the node 300 may include one, two, or more physical resources 320 in other embodiments. The physical resources 320 may be embodied as any type of processor, controller, or other compute circuit capable of performing various tasks such as compute functions and/or controlling the functions of the node 300 depending on, for example, the type or intended functionality of the node 300. For example, as discussed in more detail below, the physical resources 320 may be embodied as high-performance processors in embodiments in which the node 300 is embodied as a compute node, as accelerator co-processors or circuits in embodiments in which the node 300 is embodied as an accelerator node, storage controllers in embodiments in which the node 300 is embodied as a storage node, or a set of memory devices in embodiments in which the node 300 is embodied as a memory node.

The node 300 also includes one or more additional physical resources 330 mounted to the top side 350 of the circuit board substrate 302. In the illustrative embodiment, the additional physical resources include a network interface controller (NIC) as discussed in more detail below. Some examples of a NIC are part of an Infrastructure Processing Unit (IPU) or data processing unit (DPU) or utilized by an IPU or DPU. An IPU or DPU can include a network interface, memory devices, and one or more programmable or fixed function processors (e.g., CPU or XPU) to perform offload of operations that could have been performed by a host CPU or XPU or remote CPU or XPU. In some examples, the IPU or DPU can perform virtual switch operations, manage storage transactions (e.g., compression, cryptography, virtualization), and manage operations performed on other IPUs, DPUs, servers, or devices.

Of course, depending on the type and functionality of the node 300, the physical resources 330 may include additional or other electrical components, circuits, and/or devices in other embodiments.

The physical resources 320 can be communicatively coupled to the physical resources 330 via an input/output (I/O) subsystem 322. The I/O subsystem 322 may be embodied as circuitry and/or components to facilitate input/output operations with the physical resources 320, the physical resources 330, and/or other components of the node 300. For example, the I/O subsystem 322 may be embodied as, or otherwise include, memory controller hubs, input/output control hubs, integrated sensor hubs, firmware devices, communication links (for example, point-to-point links, bus links, wires, cables, waveguides, light guides, printed circuit board traces, etc.), and/or other components and subsystems to facilitate the input/output operations.

In some embodiments, the node 300 may also include a resource-to-resource interconnect 324. The resource-to-resource interconnect 324 may be embodied as any type of communication interconnect capable of facilitating resource-to-resource communications. In the illustrative embodiment, the resource-to-resource interconnect 324 is embodied as a high-speed point-to-point interconnect (for example, faster than the I/O subsystem 322). For example, the resource-to-resource interconnect 324 may be embodied as a QuickPath Interconnect (QPI), an UltraPath Interconnect (UPI), PCI express (PCIe), CXL, Universal Chiplet Interconnect Express (UCIe) or other high-speed point-to-point interconnect dedicated to resource-to-resource communications.

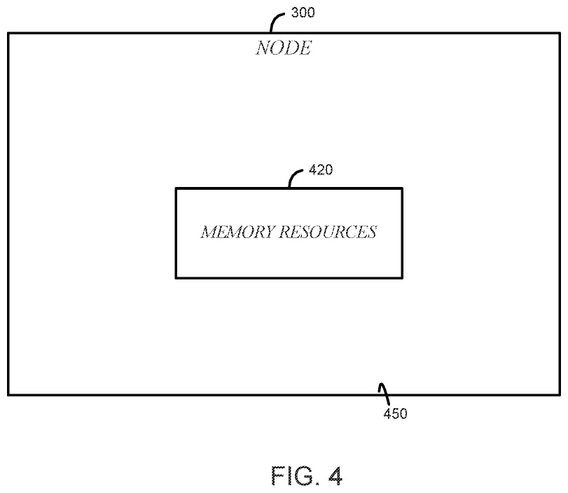

The node 300 also includes a power connector 340 configured to mate with a corresponding power connector of the rack 240 when the node 300 is mounted in the corresponding rack 240. The node 300 receives power from a power supply of the rack 240 via the power connector 340 to supply power to the various electrical components of the node 300. That is, the node 300 does not include any local power supply (for example, an on-board power supply) to provide power to the electrical components of the node 300. The exclusion of a local or on-board power supply facilitates the reduction in the overall footprint of the circuit board substrate 302, which may increase the thermal cooling characteristics of the various electrical components mounted on the circuit board substrate 302 as discussed above. In some embodiments, voltage regulators are placed on a bottom side 450 (see FIG. 4) of the circuit board substrate 302 directly opposite of the processors 520 (see FIG. 5), and power is routed from the voltage regulators to the processors 520 by vias extending through the circuit board substrate 302. Such a configuration provides an increased thermal budget, additional current and/or voltage, and better voltage control relative to typical printed circuit boards in which processor power is delivered from a voltage regulator, in part, by printed circuit traces.

In some embodiments, the node 300 may also include mounting features 342 configured to mate with a mounting arm, or other structure, of a robot to facilitate the placement of the node 300 in a rack 240 by the robot. The mounting features 342 may be embodied as any type of physical structures that allow the robot to grasp the node 300 without damaging the circuit board substrate 302 or the electrical components mounted thereto. For example, in some embodiments, the mounting features 342 may be embodied as non-conductive pads attached to the circuit board substrate 302. In other embodiments, the mounting features may be embodied as brackets, braces, or other similar structures attached to the circuit board substrate 302. The particular number, shape, size, and/or make-up of the mounting feature 342 may depend on the design of the robot configured to manage the node 300.

Referring now to FIG. 4, in addition to the physical resources 330 mounted on the top side 350 of the circuit board substrate 302, the node 300 also includes one or more memory devices 420 mounted to a bottom side 450 of the circuit board substrate 302. That is, the circuit board substrate 302 can be embodied as a double-sided circuit board. The physical resources 320 can be communicatively coupled to memory devices 420 via the I/O subsystem 322. For example, the physical resources 320 and the memory devices 420 may be communicatively coupled by one or more vias extending through the circuit board substrate 302. A physical resource 320 may be communicatively coupled to a different set of one or more memory devices 420 in some embodiments. Alternatively, in other embodiments, each physical resource 320 may be communicatively coupled to each memory device 420.

The memory devices 420 may be embodied as any type of memory device capable of storing data for the physical resources 320 during operation of the node 300, such as any type of volatile (for example, dynamic random access memory (DRAM), etc.) or non-volatile memory. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies, for example, multi-threshold level NAND flash memory and NOR flash memory. A block can be any size such as but not limited to 2 KB, 4 KB, 5 KB, and so forth. A memory device may also include next-generation nonvolatile devices, such as Intel Optane® memory or other byte addressable write-in-place nonvolatile memory devices, for example, memory devices that use chalcogenide glass, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, the memory device may comprise a transistor-less stackable cross point architecture in which memory cells sit at the intersection of word lines and bit lines and are individually addressable and in which bit storage is based on a change in bulk resistance.

Referring now to FIG. 5, in some embodiments, the node 300 may be embodied as a compute node 500. The compute node 500 can be configured to perform compute tasks. Of course, as discussed above, the compute node 500 may rely on other nodes, such as acceleration nodes and/or storage nodes, to perform compute tasks.

In the illustrative compute node 500, the physical resources 320 are embodied as processors 520. Although only two processors 520 are shown in FIG. 5, it should be appreciated that the compute node 500 may include additional processors 520 in other embodiments. Illustratively, the processors 520 are embodied as high-performance processors 520 and may be configured to operate at a relatively high power rating.

In some embodiments, the compute node 500 may also include a processor-to-processor interconnect 542. Processor-to-processor interconnect 542 may be embodied as any type of communication interconnect capable of facilitating processor-to-processor interconnect 542 communications. In the illustrative embodiment, the processor-to-processor interconnect 542 is embodied as a high-speed point-to-point interconnect (for example, faster than the I/O subsystem 322). For example, the processor-to-processor interconnect 542 may be embodied as a QuickPath Interconnect (QPI), an UltraPath Interconnect (UPI), or other high-speed point-to-point interconnect dedicated to processor-to-processor communications (for example, PCIe or CXL).

The compute node 500 also includes a communication circuit 530. The illustrative communication circuit 530 includes a network interface controller (NIC) 532, which may also be referred to as a host fabric interface (HFI). The NIC 532 may be embodied as, or otherwise include, any type of integrated circuit, discrete circuits, controller chips, chipsets, add-in-boards, daughtercards, network interface cards, or other devices that may be used by the compute node 500 to connect with another compute device (for example, with other nodes 300). In some embodiments, the NIC 532 may be embodied as part of a system-on-a-chip (SoC) that includes one or more processors, or included on a multichip package that also contains one or more processors. In some embodiments, the NIC 532 may include a local processor (not shown) and/or a local memory (not shown) that are both local to the NIC 532. In such embodiments, the local processor of the NIC 532 may be capable of performing one or more of the functions of the processors 520. Additionally, or alternatively, in such embodiments, the local memory of the NIC 532 may be integrated into one or more components of the compute node at the board level, socket level, chip level, and/or other levels. In some examples, a network interface includes a network interface controller or a network interface card. In some examples, a network interface can include one or more of a network interface controller (NIC) 532, a host fabric interface (HFI), a host bus adapter (HBA), network interface connected to a bus or connection (for example, PCIe, CXL, DDR, and so forth). In some examples, a network interface can be part of a switch or a system-on-chip (SoC). The NIC 532 can communicate using a network protocol such as Ethernet (Institute of Electrical and Electronics Engineers (IEEE) 802.3 standard).

The communication circuit 530 is communicatively coupled to an optical data connector 534. The optical data connector 534 is configured to mate with a corresponding optical data connector of a rack when the compute node 500 is mounted in the rack. Illustratively, the optical data connector 534 includes a plurality of optical fibers which lead from a mating surface of the optical data connector 534 to an optical transceiver 536. The optical transceiver 536 is configured to convert incoming optical signals from the rack-side optical data connector to electrical signals and to convert electrical signals to outgoing optical signals to the rack-side optical data connector. Although shown as forming part of the optical data connector 534 in the illustrative embodiment, the optical transceiver 536 may form a portion of the communication circuit 530 or even processor 520 in other embodiments.

In some embodiments, the compute node 500 may also include an expansion connector 540. In such embodiments, the expansion connector 540 is configured to mate with a corresponding connector of an expansion circuit board substrate to provide additional physical resources to the compute node 500. The additional physical resources may be used, for example, by the processors 520 during operation of the compute node 500. The expansion circuit board substrate may be substantially similar to the circuit board substrate 302 discussed above and may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits.

Referring now to FIG. 6, in some embodiments, the node 300 may be embodied as an accelerator node 600. The accelerator node 600 is configured to perform specialized compute tasks, such as machine learning, encryption, hashing, or another computational-intensive task. In some embodiments, for example, a compute node 500 may offload tasks to the accelerator node 600 during operation. The accelerator node 600 includes various components similar to components of the node 300 and/or compute node 500, which have been identified in FIG. 6 using the same reference numbers.

In the illustrative accelerator node 600, the physical resources 320 are embodied as accelerator circuits 620. Although only two accelerator circuits 620 are shown in FIG. 6, it should be appreciated that the accelerator node 600 may include additional accelerator circuits 620 in other embodiments. The accelerator circuits 620 may be embodied as any type of processor, co-processor, compute circuit, or other device capable of performing compute or processing operations. For example, the accelerator circuits 620 may be embodied as, for example, central processing units, cores, field programmable gate arrays (FPGA), application-specific integrated circuits (ASICs), programmable control logic (PCL), security co-processors, graphics processing units (GPUs), neuromorphic processor units, quantum computers, machine learning circuits, or other specialized processors, controllers, devices, and/or circuits.

In some embodiments, the accelerator node 600 may also include an accelerator-to-accelerator interconnect 642. Similar to the resource-to-resource interconnect 324 of the node 300 discussed above, the accelerator-to-accelerator interconnect 642 may be embodied as any type of communication interconnect capable of facilitating accelerator-to-accelerator communications. In the illustrative embodiment, the accelerator-to-accelerator interconnect 642 is embodied as a high-speed point-to-point interconnect (for example, faster than the I/O subsystem 622). For example, the accelerator-to-accelerator interconnect 642 may be embodied as a QuickPath Interconnect (QPI), an UltraPath Interconnect (UPI), or other high-speed point-to-point interconnect dedicated to processor-to-processor communications. In some embodiments, the accelerator circuits 620 may be daisy-chained with a primary accelerator circuit 620 connected to the NIC 532 and memory 420 through the I/O subsystem 622 and a secondary accelerator circuit 620 connected to the NIC 532 and memory 420 through a primary accelerator circuit 620.

Referring now to FIG. 7, in some embodiments, the node 300 may be embodied as a storage node 700. The storage node 700 is configured to store data in a data storage 750 local to the storage node 700. For example, during operation, a compute node 500 or an accelerator node 600 may store and retrieve data from the data storage 750 of the storage node 700. The storage node 700 includes various components similar to components of the node 300 and/or the compute node 500, which have been identified in FIG. 7 using the same reference numbers.

In the illustrative storage node 700, the physical resources 320 are embodied as storage controllers 720. Although only two storage controllers 720 are shown in FIG. 7, it should be appreciated that the storage node 700 may include additional storage controllers 720 in other embodiments. The storage controllers 720 may be embodied as any type of processor, controller, or control circuit capable of controlling the storage and retrieval of data into the data storage 750 based on requests received via the communication circuit 530. In the illustrative embodiment, the storage controllers 720 are embodied as relatively low-power processors or controllers. For example, in some embodiments, the storage controllers 720 may be configured to operate at a power rating of about 75 watts.

In some embodiments, the storage node 700 may also include a controller-to-controller interconnect 742. Similar to the resource-to-resource interconnect 324 of the node 300 discussed above, the controller-to-controller interconnect 742 may be embodied as any type of communication interconnect capable of facilitating controller-to-controller communications. In the illustrative embodiment, the controller-to-controller interconnect 742 is embodied as a high-speed point-to-point interconnect (for example, faster than the I/O subsystem 622). For example, the controller-to-controller interconnect 742 may be embodied as a QuickPath Interconnect (QPI), an UltraPath Interconnect (UPI), or other high-speed point-to-point interconnect dedicated to processor-to-processor communications.

Referring now to FIG. 8, in some embodiments, the node 300 may be embodied as a memory node 800. The memory node 800 is configured to provide other nodes 300 (for example, compute nodes 500, accelerator nodes 600, etc.) with access to a pool of memory (for example, in two or more sets 830, 832 of memory devices 420) local to the storage node 700. For example, during operation, a compute node 500 or an accelerator node 600 may remotely write to and/or read from one or more of the memory sets 830, 832 of the memory node 800 using a logical address space that maps to physical addresses in the memory sets 830, 832.

In the illustrative memory node 800, the physical resources 320 are embodied as memory controllers 820. Although only two memory controllers 820 are shown in FIG. 8, it should be appreciated that the memory node 800 may include additional memory controllers 820 in other embodiments. The memory controllers 820 may be embodied as any type of processor, controller, or control circuit capable of controlling the writing and reading of data into the memory sets 830, 832 based on requests received via the communication circuit 530. In the illustrative embodiment, each memory controller 820 is connected to a corresponding memory set 830, 832 to write to and read from memory devices 420 within the corresponding memory set 830, 832 and enforce any permissions (for example, read, write, etc.) associated with node 300 that has sent a request to the memory node 800 to perform a memory access operation (for example, read or write).

In some embodiments, the memory node 800 may also include a controller-to-controller interconnect 842. Similar to the resource-to-resource interconnect 324 of the node 300 discussed above, the controller-to-controller interconnect 842 may be embodied as any type of communication interconnect capable of facilitating controller-to-controller communications. In the illustrative embodiment, the controller-to-controller interconnect 842 is embodied as a high-speed point-to-point interconnect (for example, faster than the I/O subsystem 622). For example, the controller-to-controller interconnect 842 may be embodied as a QuickPath Interconnect (QPI), an UltraPath Interconnect (UPI), or other high-speed point-to-point interconnect dedicated to processor-to-processor communications. As such, in some embodiments, a memory controller 820 may access, through the controller-to-controller interconnect 842, memory that is within the memory set 832 associated with another memory controller 820. In some embodiments, a scalable memory controller is made of multiple smaller memory controllers, referred to herein as “chiplets”, on a memory node (for example, the memory node 800). The chiplets may be interconnected (for example, using EMIB (Embedded Multi-Die Interconnect Bridge)). The combined chiplet memory controller may scale up to a relatively large number of memory controllers and I/O ports, (for example, up to 16 memory channels). In some embodiments, the memory controllers 820 may implement a memory interleave (for example, one memory address is mapped to the memory set 830, the next memory address is mapped to the memory set 832, and the third address is mapped to the memory set 830, etc.). The interleaving may be managed within the memory controllers 820, or from CPU sockets (for example, of the compute node 500) across network links to the memory sets 830, 832, and may improve the latency associated with performing memory access operations as compared to accessing contiguous memory addresses from the same memory device.

Further, in some embodiments, the memory node 800 may be connected to one or more other nodes 300 (for example, in the same rack 240 or an adjacent rack 240) through a waveguide, using the waveguide connector 880. In the illustrative embodiment, the waveguides are 64 millimeter waveguides that provide 16 Rx (for example, receive) lanes and 16 Tx (for example, transmit) lanes. Each lane, in the illustrative embodiment, is either 16 GHz or 32 GHz. In other embodiments, the frequencies may be different. Using a waveguide may provide high throughput access to the memory pool (for example, the memory sets 830, 832) to another node (for example, a node 300 in the same rack 240 or an adjacent rack 240 as the memory node 800) without adding to the load on the optical data connector 534.

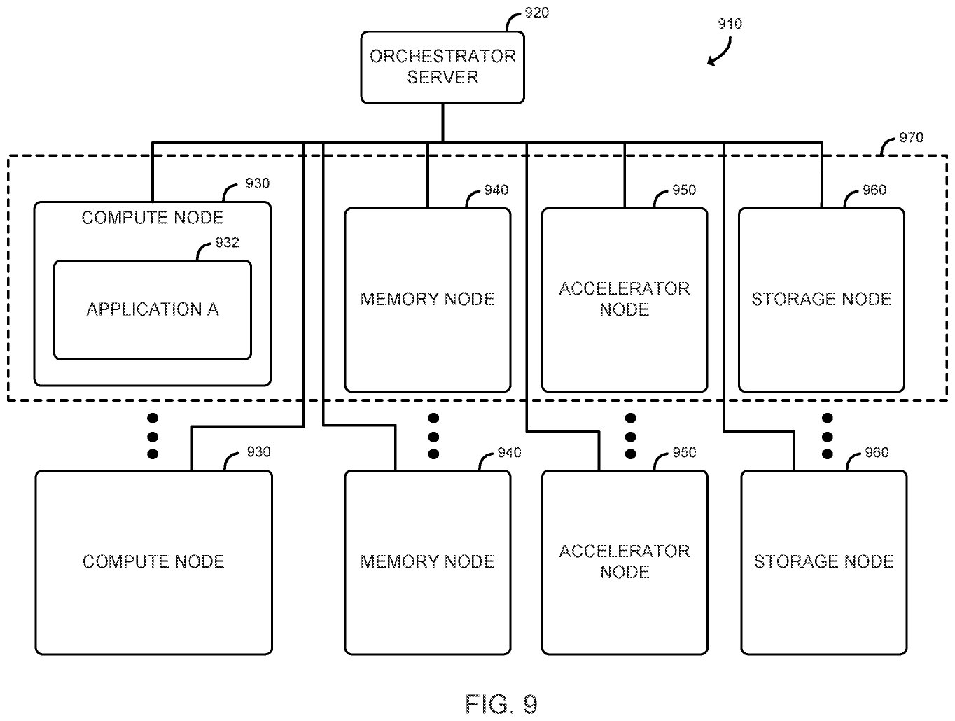

Referring now to FIG. 9, a system 910 for executing one or more workloads (for example, applications) may be implemented. In the illustrative embodiment, the system 910 includes an orchestrator server 920, which may be embodied as a managed node comprising a compute device (for example, a processor 520 on a compute node 500) executing management software (for example, a cloud operating environment, such as OpenStack) that is communicatively coupled to multiple nodes 300 including a large number of compute nodes 930 (for example, each similar to the compute node 500), memory nodes 940 (for example, each similar to the memory node 800), accelerator nodes 950 (for example, each similar to the accelerator node 600), and storage nodes 960 (for example, each similar to the storage node 700). One or more of the nodes 930, 940, 950, 960 may be grouped into a managed node 970, such as by the orchestrator server 920, to collectively perform a workload (for example, an application 932 executed in a virtual machine or in a container).

The managed node 970 may be embodied as an assembly of physical resources 320, such as processors 520, memory resources 420, accelerator circuits 620, or data storage 750, from the same or different nodes 300. Physical resources 320 from the same compute node 500 or the same memory node 800 or the same accelerator node 600 or the same storage node 700 can be assigned to a single managed node 970. Alternatively, physical resources 320 from the same node 300 can be assigned to different managed nodes 970. Further, the managed node may be established, defined, or “spun up” by the orchestrator server 920 at the time a workload is to be assigned to the managed node or at any other time, and may exist regardless of whether any workloads are presently assigned to the managed node. In the illustrative embodiment, the orchestrator server 920 may selectively allocate and/or deallocate physical resources 320 from the nodes 300 and/or add or remove one or more nodes 300 from the managed node 970 as a function of quality of service (QoS) targets (for example, a target throughput, a target latency, a target number of instructions per second, etc.) associated with a service level agreement for the workload (for example, the application 932). In doing so, the orchestrator server 920 may receive telemetry data indicative of performance conditions (for example, throughput, latency, instructions per second, etc.) in each node 300 of the managed node 970 and compare the telemetry data to the quality of service targets to determine whether the quality of service targets are being satisfied. The orchestrator server 920 may additionally determine whether one or more physical resources may be deallocated from the managed node 970 while still satisfying the QoS targets, thereby freeing up those physical resources for use in another managed node (for example, to execute a different workload). Alternatively, if the QoS targets are not presently satisfied, the orchestrator server 920 may determine to dynamically allocate additional physical resources to assist in the execution of the workload (for example, the application 932) while the workload is executing. Similarly, the orchestrator server 920 may determine to dynamically deallocate physical resources from a managed node if the orchestrator server 920 determines that deallocating the physical resource would result in QoS targets still being met.

Additionally, in some embodiments, the orchestrator server 920 may identify trends in the resource utilization of the workload (for example, the application 932), such as by identifying phases of execution (for example, time periods in which different operations, each having different resource utilizations characteristics, are performed) of the workload (for example, the application 932) and pre-emptively identifying available resources in the data center and allocating them to the managed node 970 (for example, within a predefined time period of the associated phase beginning). In some embodiments, the orchestrator server 920 may model performance based on various latencies and a distribution scheme to place workloads among compute nodes and other resources (for example, accelerator nodes, memory nodes, storage nodes) in the data center. For example, the orchestrator server 920 may utilize a model that accounts for the performance of resources on the nodes 300 (for example, FPGA performance, memory access latency, etc.) and the performance (for example, congestion, latency, bandwidth) of the path through the network to the resource (for example, FPGA). As such, the orchestrator server 920 may determine which resource(s) should be used with which workloads based on the total latency associated with each potential resource available in the data center 100 (for example, the latency associated with the performance of the resource itself in addition to the latency associated with the path through the network between the compute node executing the workload and the node 300 on which the resource is located).

In some embodiments, the orchestrator server 920 may generate a map of heat generation in the data center 100 using telemetry data (for example, temperatures, fan speeds, etc.) reported from the nodes 300 and allocate resources to managed nodes as a function of the map of heat generation and predicted heat generation associated with different workloads, to maintain a target temperature and heat distribution in the data center 100. Additionally or alternatively, in some embodiments, the orchestrator server 920 may organize received telemetry data into a hierarchical model that is indicative of a relationship between the managed nodes (for example, a spatial relationship such as the physical locations of the resources of the managed nodes within the data center 100 and/or a functional relationship, such as groupings of the managed nodes by the users the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (for example, cause a different internal temperature, use a different percentage of processor or memory capacity) across the resources of different managed nodes. The orchestrator server 920 may determine the differences based on the telemetry data stored in the hierarchical model and factor the differences into a prediction of future resource utilization of a workload if the workload is reassigned from one managed node to another managed node, to accurately balance resource utilization in the data center 100. In some embodiments, the orchestrator server 920 may identify patterns in resource utilization phases of the workloads and use the patterns to predict future resource utilization of the workloads.

To reduce the computational load on the orchestrator server 920 and the data transfer load on the network, in some embodiments, the orchestrator server 920 may send self-test information to the nodes 300 to enable each node 300 to locally (for example, on the node 300) determine whether telemetry data generated by the node 300 satisfies one or more conditions (for example, an available capacity that satisfies a predefined threshold, a temperature that satisfies a predefined threshold, etc.). Each node 300 may then report back a simplified result (for example, yes or no) to the orchestrator server 920, which the orchestrator server 920 may utilize in determining the allocation of resources to managed nodes.

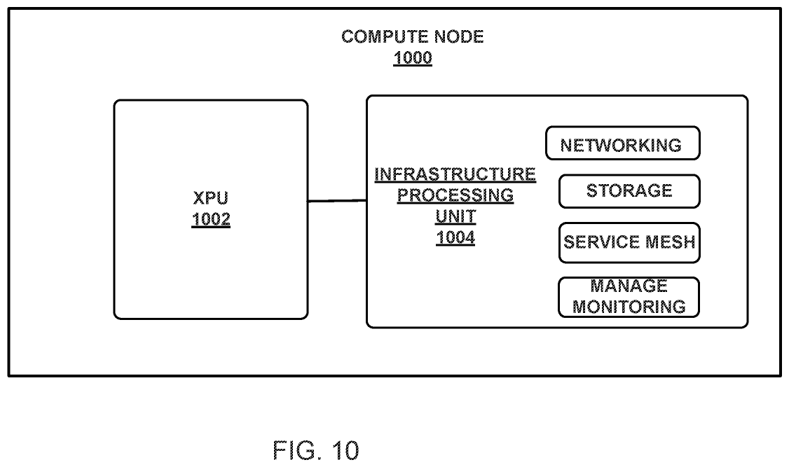

FIG. 10 illustrates a compute node 1000 that includes an Infrastructure Processing Unit (IPU) 1004 and an xPU 1002. An XPU or xPU can refer to a Central processing unit (CPU), graphics processing unit (GPU), general purpose GPU (GPGPU), field programmable gate array (FPGA), Accelerated Processing Unit (APU), Artificial Intelligence processing Unit (AIPU), an Image/Video Processing Unit (VPU), accelerator or another processor. These can also include functions such as quality of service enforcement, tracing, performance and error monitoring, logging, authentication, service mesh, data transformation, etc.

Infrastructure Processing Units (IPUs) also referred to as Data Processing Units (DPUs) can be used by CSPs for performance, management, security and coordination functions in addition to infrastructure offload and communications. For example, IPUs can be integrated with smart NICs and storage or memory (for example, on a same die, system on chip (SoC), or connected dies) that are located at on-premises systems, base stations, gateways, neighborhood central offices, and so forth.

The IPU 1004 can perform an application composed of microservices. Microservices can include a decomposition of a monolithic application into small manageable defined services. Each microservice runs in its own process and communicates using protocols (for example, a Hypertext Transfer Protocol (HTTP) resource application programming interfaces (API), message service or Google remote procedure call (gRPC) calls/messages). Microservices can be independently deployed using centralized management of these services.

The IPU 1004 can execute platform management, networking stack processing operations, security (crypto) operations, storage software, identity and key management, telemetry, logging, monitoring and service mesh (e.g., control how different microservices communicate with one another). The IPU 1004 can access the xPU 1002 to offload performance of various tasks.

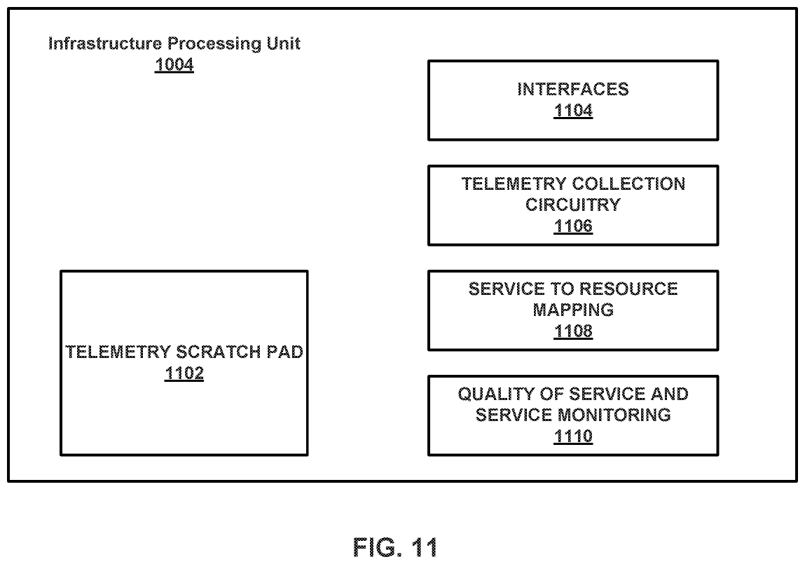

FIG. 11 is a block diagram including logic/circuitry in the IPU 1004 to store and process telemetry data. The IPU 1004 includes interfaces 1104, telemetry collection circuitry 1106, service to resource mapping circuitry 1108, quality of service and service monitoring circuitry 1110 and a telemetry scratch pad 1102.

Interfaces 1104 includes circuitry to allow devices, for example a compute node connected to the IPU 1004 to send telemetry data to the IPU 1004. Interfaces 1104 also includes circuitry to configure and manage telemetry collection circuitry 1106, and to allow external systems, for example, a data analytics node to retrieve raw telemetry data and/or processed telemetry data (hints/outcomes) for Key Performance Indicator (KPI)/Service Level Agreement (SLA) monitoring and improving microservices scheduling.

Telemetry collection circuitry 1106 collects and performs initial processing of telemetry data received from connected nodes and the IPU's networking subsystem.

Service to resource mapping circuitry 1108 creates a “fingerprint” of the service (for example, a microservice or an application) that is based on the type of resources that are used by the service and how the resources are used by the service.

Quality of Service and Service monitoring circuitry 1110 monitors and detects performance issues and bottlenecks associated with the service. Quality of Service & Service monitoring circuitry 1110 can detect Service Level Objective (SLO) violations (for example, if the service response latency is greater than the threshold set in the SLA for the service). A SLO is part of a SLA.

Quality of Service and Service monitoring circuitry 1110 also maps SLOs to resource utilization (e.g. increased latency is due to insufficient network bandwidth allocated for the service).

The telemetry scratch pad 1102 is used to store intermediary telemetry data while processing the telemetry data to obtain final processed telemetry data (for example, intermediary telemetry data is generated while correlating networking telemetry data with microservice CPU utilization).

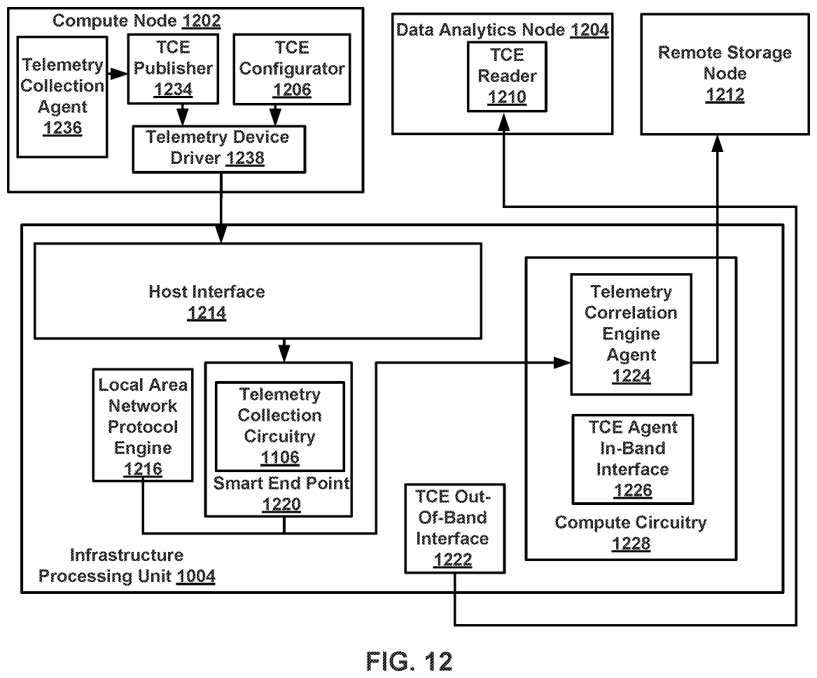

FIG. 12 is a block diagram of a system that includes the IPU 1004 to store and process host telemetry data and network telemetry data. The system also includes a compute node 1202, a data analytics node 1204 and a remote storage node 1212. Interfaces 1104 in the IPU 1004 includes a Telemetry Correlation Engine (TCE) agent in-band interface 1226 and a TCE out-of-band interface 1222.

The IPU 1004 includes Telemetry Collection circuitry 1106 to correlate (show a causal a relationship between) host level telemetry data and network telemetry data to identify performance bottlenecks for microservices based applications. For example, host level telemetry data can include CPU utilization by a workload and network telemetry data can include network bandwidth. The Telemetry Collection circuitry 1106 to correlate a decrease in CPU utilization by the workload is based on insufficient network bandwidth because no data has been received from the network for the workload. The result of the correlation (insufficient network bandwidth) can be referred to as processed telemetry data (hints/outcomes). The processed telemetry data to identify one or more performance bottlenecks (insufficient network bandwidth).

In another example, network telemetry data can include number of bytes received for encrypted traffic and host level telemetry data can include CPU utilization for processing encrypted data. The Telemetry Collection circuitry 1106 to calculate a “security tax” by comparing: a) the number of bytes received and CPU utilization for encrypted traffic with b) the number of bytes received and CPU utilization for unencrypted traffic.

In yet another example, network telemetry data can include latency and host telemetry data can include CPU resource utilization. The Telemetry Collection circuitry 1106 to correlate increased latency on the network (cause) with requests to the workload timing-out (result) and consumption of CPU resources by other software for error tracking (observable side-effect).

Examples of network telemetry data include In-band Network Telemetry (INT) and Platform Management Monitoring (PMT). Examples of host level telemetry data include a container and a pod. A pod is the basic execution unit of a Kubernetes application, the smallest and simplest unit in the Kubernetes object model that can be created or deployed. The pod represents a unit of deployment: a single instance of an application in Kubernetes, which can include either a single container or a small number of containers that are tightly coupled and that share resources.

The pod is a group of one or more containers with shared storage/network. Containers within a pod share an Internet Protocol (IP) address and port space and can communicate with other pods using standard inter-process communications. Containers in different pods have distinct Internet Protocol addresses and communicate with each other using IP addresses for pods.

The IPU 1004 is aware of the topological characteristics of the application, local resources, remote resources and performance requirements associated with the services. Examples of local resources include platform resources and Compute Express Link™ (CXL™) attached resources. CXL™ is an industry-supported Cache-Coherent Interconnect for Processors, Memory Expansion and Accelerators. Examples of remote resources include CXL™ over fabric and remote storage. The performance requirements can be a Service Level Agreement (SLA) or a Service Level Objective (SLO).

The IPU 1004 can track an application Key Performance Indicator (KPI) of the different services running on the system and establish Service Level Agreement violations and correlate them with the different topological building blocks that are part of the service or application. Using this end-to-end telemetry and using techniques such as Top-down Microarchitecture Analysis Method (TMAM), the IPU 1004 can determine performance bottlenecks such as insufficient network bandwidth, saturated queues on the IPU 1004, memory bandwidth saturation, and “elephant” flows. An “elephant” flow is an extremely large (in total bytes) continuous flow set up by a network protocol (for example, TCP) measured over a network link that can occupy a disproportionate share of the total bandwidth over a period of time. The IPU 1004 can report the performance bottlenecks to the orchestrator server 920 for remediation.

The IPU 1004 includes a host interface 1214 that includes circuitry to manage communications between the compute node 1202 and the IPU 1004. The IPU 1004 includes a Local Area Network Protocol engine 1216 (also referred to a network interface controller) to communicate with remote nodes.

The IPU 1004 also includes a Smart End Point (SEP) 1220 that exposes the telemetry collection circuitry 1106. The telemetry collection circuitry 1106 can be used to send telemetry data collected by a host-level in-band agent (for example collectd) through a SEP 1220 to a Telemetry Correlation Engine agent 1224 running in the compute circuitry 1228 in the IPU 1004. The telemetry collection circuitry 1106 can also be used to configure the Telemetry Correlation Engine agent 1224, for example to provide mapping, or additional metadata, about workloads (for example, containers) running on the compute node 1202 to facilitate telemetry correlation and analysis. The telemetry collection circuitry 1106 can also be used to read processed telemetry data from the Telemetry Correlation Engine agent 1224.

The Telemetry Correlation Engine agent 1224 in the compute circuitry 1228 includes the telemetry scratch pad 1102, service to resource mapping circuitry 1108 and quality of service and service monitoring circuitry 1110. The Telemetry Correlation Engine agent 1224 correlates in-band workload related telemetry with network related telemetry. Examples of in-band workload related telemetry include resource utilization and application performance metrics. An example of network related telemetry is per-workload network statistics, for example, number of bytes sent/received by a TCP flow, number of dropped bytes, latency between packets, queue occupancy, total bytes sent/received, bytes sent/received per destination, network bandwidth utilization by the workload, latency with communication with other workloads, and other counters for the data plane.

The network statistics can be collected using Intel Platform Monitoring Technology. Intel® Platform Monitoring Technology is an architecture for discovering and reading telemetry from a device through a hardware agnostic framework.

In another embodiment, the Telemetry Correlation Engine Agent 1224 can be in the Smart End Point 1220 instead of in the compute circuitry 1228 to save resources in the compute circuitry 1228. In yet another embodiment, the Telemetry Collection circuitry 1106 is separate from the Smart End Point 1220.

A TCE reader 1210 in a data analytics node 1204 can access processed telemetry data directly from the IPU 1004 via the TCE out-of-band interface 1222 in the IPU 1004. The Telemetry Correlation Engine agent 1224 can store the host telemetry data and the network telemetry data in a remote storage node 1212. In an embodiment, the host telemetry data and the network telemetry data is stored in the remote storage node 1212 using the NVMe (NVM Express) over PCIe (Peripheral Component Interconnect Express) protocol. Non-Volatile Memory Express (NVMe) standards define a register level interface to communicate over Peripheral Component Interconnect Express (PCIe), a high-speed serial computer expansion bus. The NVM Express standards are available at www.nvmexpress.org. The PCIe standards are available at pcisig.com.

A telemetry collection agent 1236 (for example collectd) in the compute node 1202 gathers per-workload (for example, per container) telemetry (host level telemetry data) and uses a TCE publisher 1234 to send the host level telemetry data via a telemetry device driver 1238 and the Telemetry collection circuitry 1106 in the SEP 1220 to the Telemetry Correlation Engine agent 1224.

A TCE configurator 1206 in the compute node 1202 configures the Telemetry Correlation Engine agent 1224 in the IPU 1004. As the Kubernetes pods (containers) that are running on the compute node 1202 vary over time, the TCE configurator 1206 regularly sends status of the pods (containers) to the IPU 1004 so that the IPU 1004 is aware of the pods (containers) that are currently running on the compute node 1202.

The TCE configurator 1206 also provides mapping of IP-port to pod (container) name and provides additional data to indicate which pods (containers) are part of the same application (to facilitate performance issue root-causing for microservices based applications). The configuration of the Telemetry Correlation Engine agent 1224 is adjusted to Cloud Service Operator needs and use cases. Telemetry correlation/processing can be performed in the compute circuitry 1228 or the Smart End Point 1220 and can be delivered via a telemetry device configuration function. For example, telemetry correlation/processing can calculate an average packet latency over some time interval (or any other statistical values), or detect that increased response time is due to queues that are full. The telemetry correlation/processing associates host level telemetry (one source) with network telemetry (other source) for the same microservice. Telemetry correlation/processing can also detect how one telemetry data depends on other telemetry data (for example, increased latency is due to queue overfill).

The TCE reader 1210 in the data analytics node 1204 can read processed data from the Telemetry Correlation Engine agent 1224. This data can indicate which microservices are causing performance degradation of an application and the potential root-cause (for example, number of receive queues are increasing because the microservice cannot process data because there are insufficient compute/CPU resources).

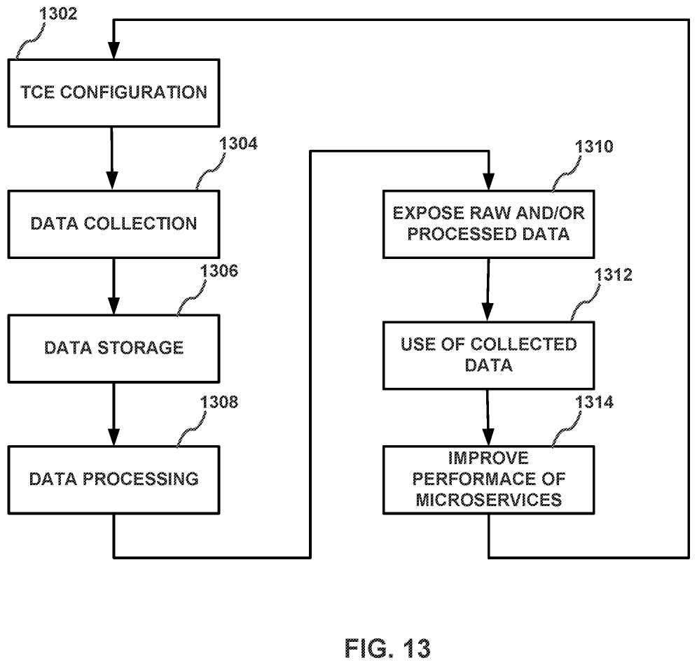

FIG. 13 is a flowgraph illustrating a method performed in the IPU 1004 shown in FIG. 12 to improve performance of microservices.

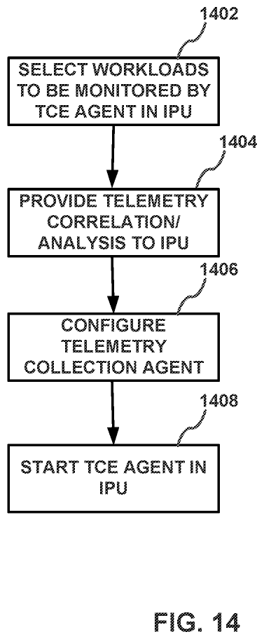

At block 1302, the compute node 1202 performs TCE configuration in the IPU 1004. TCE configuration includes uploading SLA and KPI targets to the IPU 1004 for microservices. TCE configuration will be described later in conjunction with FIG. 14.

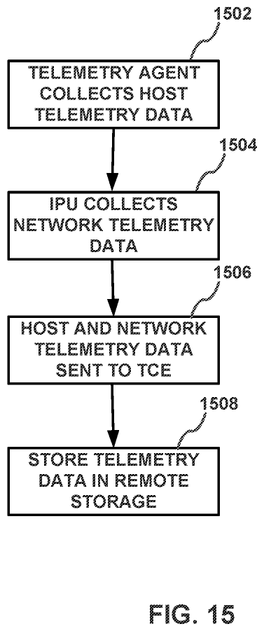

At block 1304, the IPU 1004 performs data collection. Data collection will be described later in conjunction with FIG. 15.

At block 1306, the IPU 1004 can store data that is collected in the remote storage node 1212.

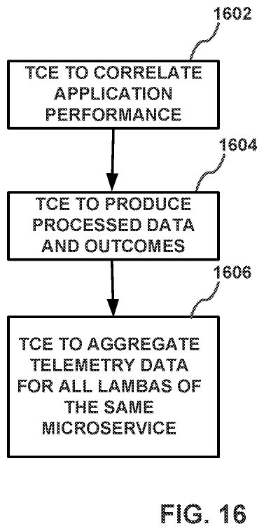

At block 1308, the IPU 1004 performs data processing using the collected data. Data processing will be described later in conjunction with FIG. 16.

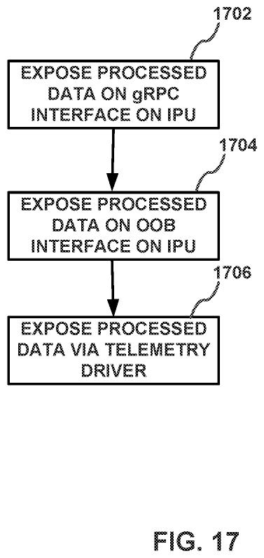

At block 1310, the IPU 1004 exposes raw and/or processed data which will be described later in conjunction with FIG. 17.

At block 1312, the exposed raw and/or processed data can be used by other servers, for example, by the orchestrator server 920 or a server to perform analytics and/or billing.

At block 1314, exposed raw and/or processed data can be used to improve the performance of microservices. For example, performance can be improved by rescheduling, scaling or allocating more resources.

FIG. 14 is a flowgraph illustrating a method for configuring the IPU 1004 to store and process telemetry data.

At block 1402, the TCE configurator 1206 in the compute node 1202 specifies identifiers (IDs) for workloads. An example of an ID for a workload is IP-port to container/pod name mapping. The workloads are monitored by the Telemetry Correlation Engine circuitry 128.

At block 1404, the TCE publisher 1234 in the compute node 1202 sends a telemetry correlation/analysis logic (for example in binary form) to be run on either the Smart End Point 1220 or the compute circuitry 1228.

At block 1406, the telemetry collection agent 1236 in the compute node 1202 uses the TCE publisher 1234 to communicate via the telemetry device driver 1238 with the IPU 1004. The telemetry collection agent 1236 collects host telemetry data on the compute node 1202 and uses the TCE publisher 1234 to send the host telemetry data via the telemetry device driver 1238 to the IPU 1004. An example of a telemetry collection agent is collectd.

At block 1408, the telemetry collection circuitry 1106 and the Telemetry Correlation Engine agent 1224 is initialized.

FIG. 15 is a flowgraph illustrating a method for performing data collection in the system shown in FIG. 12.

At block 1502, the telemetry collection agent in the compute node 1202 collects host telemetry data from the compute node 1202. Host telemetry data that is collected by the telemetry collection agent can include resource utilization, application performance metrics, and health indicators. The compute node 1202 sends/streams the telemetry data to the IPU 1004. The compute node 1202 can also be referred to as a compute host.

Resource utilization includes CPU, memory and storage utilization. CPU resource utilization includes user time and system time. User time is the amount of time a process has direct control of the CPU, executing process code. System time is the time the kernel is executing system calls on behalf of the process. Memory utilization includes cache (amount of cache memory used by processes), mapped file (amount of memory mapped by processes) and unevictable (the amount of memory that cannot be reclaimed).

Application performance metrics for an application (for example, a web server) can include total number of requests, number of requests per type of request (for example, read, write) and average time to process the request.

Examples of health indicators include number of failed requests (for example, a HTTP status code 500 indicating that the server encountered an unexpected condition that prevented it from fulfilling the request), alarms triggered due to error conditions, a missed heartbeat response, and a time-out waiting for a response

At block 1504, Intel® Platform Monitoring Technology (PMT) and/or a packet processor in the Local Area Network Protocol engine 1216 can be used by the IPU 1004 to collect network telemetry data (for example, per-workload network statistics).

At block 1506, the network telemetry data from the Local Area Network Protocol engine 1216 and the host telemetry data from the telemetry collection circuitry 1106 are sent to the Telemetry Correlation Engine agent 1224.

At block 1508, Telemetry Correlation Engine agent 1224 stores the host telemetry data and the network telemetry data in the remote storage node 1212.

FIG. 16 is a flowgraph illustrating a method for processing the host telemetry data and the network telemetry data.

At block 1602, the Telemetry Correlation Engine agent 1224 correlates application performance with resource utilization. The Telemetry Correlation Engine agent 1224 can also identify performance bottlenecks. For example, performance bottlenecks can be identified by analyzing latency in network communication between microservices.

At block 1604, the result of the correlation and identified performance bottlenecks are saved in the remote storage node 1212 to be accessed on demand or streamed via the TCE out-of-band interface 1222 or the TCE agent in-band interface 1226 by a host or Out-Of-Band interface that is accessible to the compute node 1202 via the host interface 1214. The format of the saved results can be set by a Cloud Service operator to be accessed on demand or streamed via host or the 00B interface TCE out-of-band interface 1222.

At block 1606, the IPU 1004 can be used by more than one compute node 1202. In an embodiment in which multiple compute nodes 1202 share the IPU 1004, the Telemetry Correlation Engine agent 1224 can aggregate telemetry data for all functions running inside Kubernetes pods in Function-as-a-Service models of the same microservice but spread across compute nodes 1202 that share the IPU 1004.

FIG. 17 is a flowgraph illustrating a method for exposing the data processed by the Telemetry Correlation Engine agent 1224 in the IPU 1004.

At block 1702, the processed data is exposed by the Telemetry Correlation Engine agent 1224 via the TCE agent in-band interface 1226. In an embodiment, a Remote Procedure Call (RPC), for example, a gRPC (google RPC) can be used to access the processed data.

At block 1704, the processed data is exposed by the Telemetry Correlation Engine agent 1224 on the TCE out-of-band interface 1222 on the IPU 1004.

At block 1706, the processed data is exposed by the Telemetry Correlation Engine agent 1224 to the compute node 1202 via the Telemetry device driver 1238. The telemetry device driver 1238 in the compute node 1202 is used by the TCE reader 1210 to communicate with the IPU 1004.

For example, a microservices based application that runs on the server can include a front-end (for example, Nginx (open source software for web serving, reverse proxying, caching, load balancing, and media streaming) pod, a number of processing pods and a storage pod (for example, Redis (open source, in-memory data store used as a database, cache, streaming engine, and message broker). The Telemetry Correlation Engine agent 1224 can identify Redis as a bottleneck at a given load input for the application by discovering the resources and how the resources are used by individual containers/pods.

Moving telemetry data storage and processing from the compute node 1202 to the IPU 1004 allows CPU cores in the compute node 1202 to serve user workloads. The IPU 1004 can support multiple hosts and has insight into performance data of the applications running on the multiple hosts, thus network usage between the multiple hosts and the IPU 1004 is limited to transporting telemetry data from the multiple hosts to the IPU.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. A data center comprising:
a compute node to collect host telemetry data; and
a network device, the network device comprising:
a network interface controller to collect network telemetry data;
a host interface to receive the host telemetry data from the compute node; and
circuitry to correlate the host telemetry data received from the compute node with the network telemetry data to provide processed telemetry data, the processed telemetry data to identify one or more performance bottlenecks for a microservices based application.

2. The data center of claim 1, wherein the circuitry to store the host telemetry data received from the compute node in a remote storage node.

3. The data center of claim 1, wherein the host telemetry data includes resource utilization and application performance metrics.

4. The data center of claim 1, wherein the network telemetry data includes per-workload network statistics such as a number of dropped bytes and a latency between packets.

5. The data center of claim 1, wherein the circuitry to provide the processed telemetry data to a cloud service operator.

6. The data center of claim 1, wherein the circuitry to identify the performance bottlenecks by analyzing latency in network communication between microservices.

7. The data center of claim 1, wherein the network device is an infrastructure processing unit.

8. A network device, the network device comprising:
a network interface controller to collect network telemetry data;
a host interface to receive host telemetry data from a compute node; and
circuitry to correlate the host telemetry data received from the compute node with the network telemetry data to provide processed telemetry data, the processed telemetry data to identify one or more performance bottlenecks for a microservices based application.

9. The network device of claim 8, wherein the circuitry to store the host telemetry data received from the compute node in a remote storage node.

10. The network device of claim 8, wherein the host telemetry data includes resource utilization and application performance metrics.

11. The network device of claim 8, wherein the network telemetry data includes per-workload network statistics such as a number of dropped bytes and a latency between packets.

12. The network device of claim 8, wherein the circuitry to provide the processed telemetry data to a cloud service operator.

13. The network device of claim 8, wherein the circuitry to identify the performance bottlenecks by analyzing latency in network communication between microservices.

14. The network device of claim 1, wherein the network device is an infrastructure processing unit.

15. A method comprising:
collecting, by a compute node, host telemetry data;
collecting, by a network interface controller in a network device, network telemetry data
receiving, by circuitry in the network device, the host telemetry data from the compute node and the network telemetry data from the network interface controller; and
correlating, by the circuitry in the network device, the host telemetry data received from the compute node with the network telemetry data to provide processed telemetry data, the processed telemetry data to identify one or more performance bottlenecks for a microservices based application.

16. The method of claim 15, wherein the circuitry in the network device storing host telemetry data received from the compute node in a remote storage node.

17. The method of claim 15, wherein the host telemetry data includes resource utilization, application performance metrics, and health indicators.

18. The method of claim 15, wherein the network telemetry data includes per-workload network statistics.

19. The method of claim 15, wherein the circuitry in the network device providing the processed telemetry data to a cloud service operator.

20. The method of claim 15, wherein the circuitry in the network device identifying the performance bottlenecks by analyzing latency in network communication between microservices.

21. The method of claim 15, wherein the network device is an infrastructure processing unit.
